(19) United States
(12) Patent Application Publication
(10) Pub. No.: US 2012/0285069 A1
(43) Pub. Date: Nov. 15, 2012

(54) TUBE-TYPE FISHING LURE

(76) Inventors: Kenneth Baumgardner, Monongahela, PA (US); Joshua Giran, Elizabeth, PA (US)

(21) Appl. No.: 13/107,934

(22) Filed: May 15, 2011

(51) Int. Cl. A01K 85/00; A01K 99/00

(52) U.S. Cl. 43/4.5; 43/42.35; 43/42.06

(57) ABSTRACT

A tube-type fishing lure comprises a head portion, body portion, and tail portion having respective inner surfaces that define corresponding sections of a hollow channel which extends longitudinally through the lure. The channel is configured for water to flow through the lure by entering through the head portion, passing through the body portion, and exiting through the tail portion. The head section of the channel narrows or tapers from a diameter defined at a leading edge of the head portion to a narrower width corresponding to a diameter of the body section of the channel. When the lure is pulled, twitched, and/or retrieved (e.g., reeled in) when on a fishing line, the head portion leads, and water flows through the lure in a direction opposite to the direction in which the lure travels.

### FIELD

This invention relates generally to fishing lures and, more specifically, relates to tube-type fishing lures.

### BACKGROUND

A fishing lure uses movement, vibration, and/or color to attract and hook a fish when the fish attacks the lure and bites a hook attached to the end of a fishing line. Fishing lures typically are designed to look and move like a fish's prey such as grubs, frogs, minnows, lizards, insects, and so forth.

One example of a fishing lure that can be used when trolling or when casting is a tube lure. In general, a tube lure consists of a soft plastic tube having a rounded closed end (head) and tentacles extending from an open end (tail) to resemble a crayfish—a preferred prey of bass. The tube lure is pierced with a hook, cast, and then retrieved using a twitching action so that the lure moves through the water like a swimming crayfish when reeling in the lure.

### SUMMARY

A tube-type fishing lure comprises a head portion, body portion, and tail portion having respective inner surfaces that define corresponding sections of a hollow channel which extends longitudinally through the lure. The channel is configured for water to flow through the lure by entering through the head portion, passing through the body portion, and exiting through the tail portion. The head section of the channel narrows or tapers from a diameter defined at a leading edge of the head portion to a narrower width corresponding to a diameter of the body section of the channel. When the lure is pulled, twitched, and/or retrieved (e.g., reeled in) when on a fishing line, the head portion leads, and water flows through the lure in a direction opposite to the direction in which the lure travels.

Other apparatuses according to embodiments of the present invention will be or become apparent to one with skill in the art upon examination of the following drawings and detailed description. It is intended that all such additional apparatuses are to be included within this description, to be within the scope of the present invention, and to be protected by the accompanying claims.

### BRIEF DESCRIPTION OF THE DRAWINGS

FIG. 1 illustrates a tube-type fishing lure according to one embodiment.

FIG. 2 illustrates a tube-type fishing lure according to a second embodiment.

FIG. 3 illustrates a tube-type fishing lure according to a third embodiment.

FIG. 4 illustrates a tube-type fishing lure according to a fourth embodiment.

### DETAILED DESCRIPTION

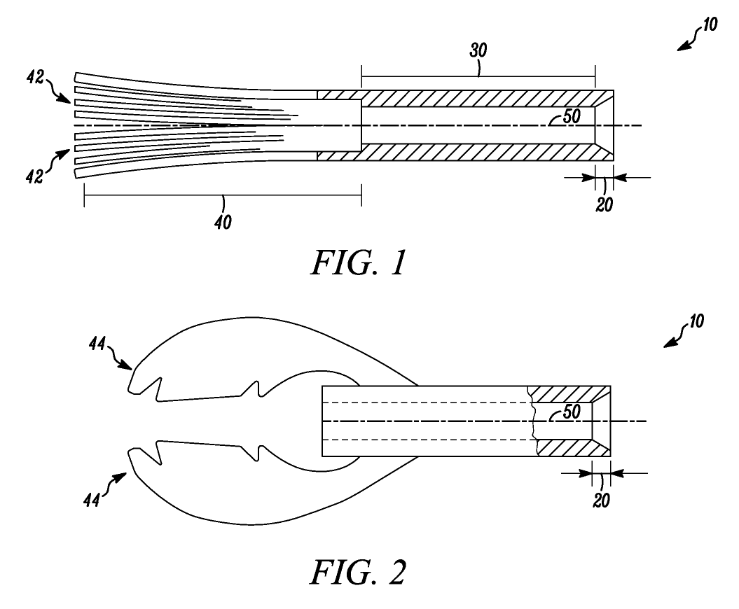

FIG. 1 illustrates a tube-type fishing lure 10 according to one embodiment. In general, the tube-type fishing lure 10 is configured to attract and lure a fish using shape and movement and can be used when trolling or when casting.

In various implementations, the lure 10 may be constructed of soft, flexible, and resilient material such as rubber, silicone, or plastic for example that can be pierced with a hook. It is to be understood that the lure 10 may be designed and/or constructed in various other ways in accordance with the described embodiments. For example, a more rigid material may be used for construction in designs which do not require the lure 10 to be pierced.

As shown, the lure 10 comprises a head portion 20, a tubular body portion 30, and a tail portion 40. The head portion 20, body portion 30, and tail portion 40 may be attached to and/or integrally formed with each other. The head portion 20, body portion, 30, and tail portion 40 have respective inner surfaces that define corresponding sections of a hollow channel 50 which extends longitudinally through the lure 10. In general, the channel 50 is configured for water to flow through the lure 10 by entering through the head portion 20, passing through the body portion 30, and exiting through the tail portion 40.

The corresponding portions of the channel 50 defined by the head portion 20, body portion 30, and tail portion 40 are configured for fluid communication with each other. A front or proximal end of the head portion 10 is open and may define a circular opening such that water may enter and flow through the lure 10 when the lure 10 travels through the water. In particular, when the lure 10 is pulled, twitched, and/or retrieved (e.g., reeled in) when on a fishing line, the head portion 10 leads, and water flows through the lure 10 in a direction opposite to the direction in which the lure 10 travels.

The head portion 20 of the lure 10 defines a head section of the channel 50, and the body portion 30 of the lure 10 defines a body section of the channel 50. As shown in FIG. 1, the body section of the channel 50 may have a constant diameter throughout the longitudinal length of the body portion 30. The front or proximal end of the head portion 20 defines a circular opening at its edge. The head section of the channel 50 narrows or tapers from a diameter of the opening defined at the edge of the proximal end of the head portion 20 to a narrower width corresponding to the diameter of the body section of the channel.

In the exemplary design shown in FIG. 1, the longitudinal length of head portion 20 is 0.125 inch, and the longitudinal length of the body portion 30 is 1.625 inches. In this design, the head portion 20 and the body portion 30 of the lure 10 may have the same 0.5 inch outer diameter. The inner surface of the body portion 30 defines a body section of the channel 50 that has a longitudinal length of 1.625 inches and a constant diameter of 0.25 inch. The front or proximal end of the head portion 20 defines an opening having an approximately 0.4 inch diameter at its leading edge. The head section of the channel 50 tapers at an angle of 30 degrees from a diameter of approximately 0.4 inch to a narrower diameter of 0.25 inch. At the point at which the head portion 20 and body portion 30 of the lure 10 meet, the channel 50 has a 0.25 diameter.

In this design, the head portion 20 of the lure 10 is configured to funnel water that enters through the circular opening the into the body portion 30. As the water is funneled by the head section of the channel 50 into the body section of the channel 50, the cross-sectional area of the channel 50 decreases which, in turn, may cause the speed or velocity of the water flowing into and through the body section of the channel to increase.

In the exemplary design of FIG. 1, the lure 10 has a longitudinal length of 3.75 inches, and the tail portion 40 has a longitudinal length of 2.00 inches. As shown, the tail portion 40 defines a tail section of the channel 50 that has a longitudinal length of 0.25 inch and a constant diameter of 0.375 inch.

In this design, an anterior part of the tail portion 40 having a longitudinal length of 0.25 inch, the body portion 30, and the head portion 20 all may have the same outer diameter of 0.5 inch. In this exemplary design, a rear part of the tail portion 40 having a longitudinal length of 1.75 inches defines a plurality of flared segments or tentacles 42. In one embodiment, the rear part of the tail portion defines twenty-four 0.0625 inch segments or tentacles.

FIG. 2 illustrates a second embodiment of the tube-type fishing lure 10 according to a different design. It is to be understood that, in the drawings, like reference numerals are intended to refer to like elements.

In this embodiment, the tail portion 40 comprises a plurality of fins 44. In one embodiment, the tail portion 40 includes two ventral fins which may be attached and or integrally formed with the lure 10.

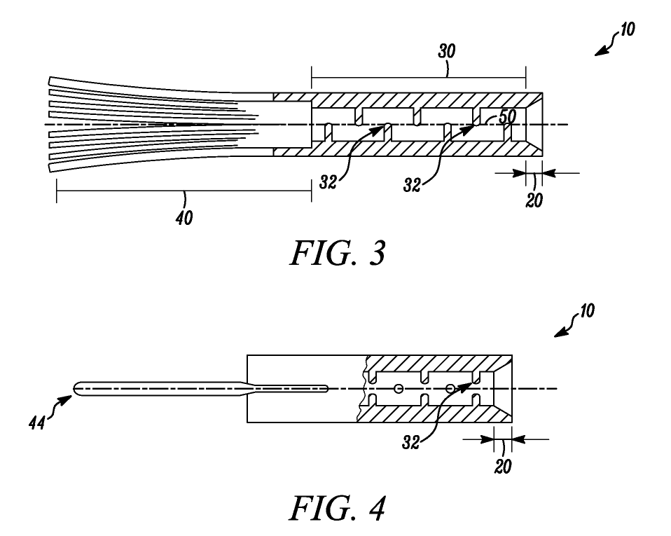

FIG. 3 illustrates a third embodiment of the tube-type fishing lure 10 according to a different design. It is to be understood that, in the drawings, like reference numerals are intended to refer to like elements.

In this embodiment, the body portion 30 of the lure 10 defines a body section of the channel 50. The body portion 30 of the lure 10 may have a 0.5 inch outer diameter, and the inner surface of the body portion 30 defines a body section of the channel 50, which may have a longitudinal length of 1.625 inches.

As shown, the inner surface of the body portion 30 includes a plurality of ribs 32 or nubs which extend into the body section of the channel. Each of the ribs 32 may be 0.0625 wide, for example. Accordingly, the body section of the channel 50 may have a fluctuating diameter throughout the longitudinal length (e.g., 1.625 inches) of the body portion 30.

In this design, the channel 50 is configured for water to flow through the lure 10 by entering through the head portion 20, passing through the body portion 30, and exiting through the tail portion 40. The head section of the channel 50 narrows or tapers to funnel water into the body section of the channel 50.

As the water flows through the body section of the channel, the ribs 32 and fluctuating diameter of the body section of the channel 50 may cause the water to experience turbulence such that the water ripples or swirls when passing through the lure 10 and/or after exiting from the lure 10.

It is to be understood that while the inner surface of the body portion 30 includes ribs 32, other designs may be employed such that the body section of the channel 50 may have a fluctuating diameter. For example, the inner surface of the body portion 30 may define grooves or threads therein. Additionally or alternatively, the body section of the channel 50 may curve or zigzag.

FIG. 4 illustrates a fourth embodiment of the tube-type fishing lure 10 according to a different design. It is to be understood that, in the drawings, like reference numerals are intended to refer to like elements.

As shown, the inner surface of the body portion 30 includes ribs 32 or nubs which extend into the body section of the channel 50. Accordingly, the body section of the channel 50 has a fluctuating diameter throughout the longitudinal length of the body portion 30. In this embodiment, the tail portion 40 comprises a plurality of fins 44, such as two ventral fins which may be attached and or integrally formed with the lure 10.

It is to be understood that the components and elements described above are illustrative but are not exhaustive. Other components and elements may be included when embodying the present invention. For example, the lure 10 may include a hook and/or an attachment mechanism such as a ring or other type of connector for attaching the lure 10 to a fishing line. The lure 10 also may include weights or sinkers.

Although the present invention has been described with regard to certain embodiments, those of ordinary skill in the art will recognize that many modifications and variations of the present invention may be implemented. For example, while specific embodiments have described certain shapes and particular dimensions, the scope of the present invention is intended to encompass other shapes and dimensions which are consistent with aspects of the present invention. The foregoing description and the following claims are intended to cover all such combinations, modifications, and variations of the described embodiments.

What is claimed is:

1. A tube-type fishing lure comprising:
a head portion, body portion, and tail portion having respective inner surfaces that define corresponding sections of a hollow channel which extends longitudinally through the lure, wherein a head section of the channel tapers from a diameter defined by an opening at a leading edge of the head portion of the lure to a narrower width corresponding to a diameter of a body section of the channel.

2. The lure of claim 1, wherein the body section of the channel has a constant diameter.

3. The lure of claim 1, wherein the body section of the channel has a fluctuating diameter.

4. The lure of claim 3, wherein the inner surface of the body portion includes ribs extending into the body section of the channel.

5. The lure of claim 3, wherein the inner surface of the body portion defines grooves.

6. The lure of claim 1, wherein the body section of the channel curves.

7. The lure of claim 1, wherein the body section of the channel zigzags.

8. The lure of claim 1, wherein the tail portion comprises a plurality of tentacles.

9. The lure of claim 1, wherein the tail portion comprises a plurality of segments.

10. The lure of claim 1, wherein the tail portion comprises a plurality of fins.

11. The lure of claim 10, wherein the fins are attached to the lure.

12. The lure of claim 10, wherein the fins are integrally formed with the lure

13. The lure of claim 10, wherein the fins are ventral fins.

14. The lure of claim 13, wherein the plurality of fins consists of two ventral fins.

15. The lure of claim 1, further comprising an attachment mechanism for attaching the lure to a fishing line.

16. The lure of claim 16, wherein the attachment mechanism comprises a ring.

17. The lure of claim 1, further comprising a sinker.

18. The lure of claim 1, further comprising a hook.

19. A method of using the tube-type fishing lure of claim 1 comprising:
casting the lure on a fishing line; and
pulling the lure using the fishing line, wherein:
the head portion leads, water enters and flows through the lure, and the head portion funnels the water into the body section of the channel causing a velocity of the water flowing into and through the body section of the channel to increase.

20. A method of using the tube-type fishing lure of claim 3 comprising:
casting the lure on a fishing line; and
pulling the lure using the fishing line, wherein:
the head portion leads, water enters and flows through the lure, and the head portion funnels the water into the body section of the channel causing a velocity of the water flowing into and through the body section of the channel to increase; and
as water flows through the body section of the channel, the ribs and fluctuating diameter of the body section of the channel cause the water to experience turbulence such that the water ripples or swirls when passing through the lure.
